(19) United States
(12) Patent Application Publication
(10) Pub. No.: US 2022/0405692 A1
(43) Pub. Date: Dec. 22, 2022

(54) Systems and Methods for Contribution Ratings

(71) Applicant: Deepak Premanand Trikannad, Irvine, CA (US)

(72) Inventor: Deepak Premanand Trikannad, Irvine, CA (US)

(21) Appl. No.: 17/841,635

(22) Filed: Jun. 15, 2022

Related U.S. Application Data
(60) Provisional application No. 63/211,968, filed on Jun. 17, 2021.

(51) Int. Cl. G06Q 10/06

(52) U.S. Cl. CPC G06Q 10/063114; G06Q 10/06393

(57) ABSTRACT

Systems and methods for contribution ratings are provided. In one embodiment, a non-transitory machine readable storage medium is provided, the non-transitory machine readable storage medium storing a program comprising instructions that, when executed by at least one processor of a server, cause the server to perform operations including: receiving first employee action data associated with a first employee; receiving second employee action data associated with a second employee; and generating a plurality of groups, wherein the plurality of groups ranks employees based on the first employee action data and the second employee action data.

### CROSS-REFERENCE TO RELATED APPLICATION

The current application claims priority to U.S. Provisional Patent Application No. 63/211,968, filed on Jun. 17, 2021, the disclosure of which is incorporated herein by reference.

### FIELD OF THE INVENTION

The present disclosure generally relates to human resources, and more specifically to systems and methods for contribution ratings.

### BACKGROUND

The term “activity” may indicate a measurement of an employee's actions in a particular workplace system (e.g., number of emails sent, hours mouse is moving vs inactive, meetings attended, minutes spoken during meeting, etc.). Typically, activity alone may not be enough for measuring contribution and/or impact of an employee to the business. For example, if an NBA player is measured based on the number of steps made during a game, this may not capture the player's contribution. Various activities may be used to define “productivity.” For example, the term “productivity” may be defined by combining multiple activities to represent productivity in a business. However, productivity in this sense may often be a misnomer. For example, combining multiple activities may be more a representation of an employee's engagement and not necessarily productivity. In many situations, engagement may not lead to productivity.

Productivity may be used to define “performance.” Performance, has historically been a subjective measure of an employee's ability to meet their goals and key performance indicators (KPIs). Typically, performance may be largely based on self-representation and immediate manager's agreement. However, the worse an employee's ability to self-advocate, the worse their performance review. Also, the worse the manager, the worse the performance review. For example, a manager may be a bad communicator, bad person, focused on projects the employee is not a part of and therefore has no perspective, or simply doesn't like the employee personally. Thus, the employee's performance metric under such conditions may be highly subjective.

Performance may be used to define “contribution.” The term “contribution” may indicate a measure of an employee's contribution towards a business outcome (e.g., sale of a new contract, revenue generation, launch of a product, marketing qualified leads, etc.). The culmination of contribution may be “impact.” The term impact may be the result and/or effect of contribution. Impact may be a measurable result (e.g., sales wins, revenue growth, product launches, marketing leads, etc.).

### SUMMARY OF THE INVENTION

The various embodiments of the present systems and methods for contribution rating (may also be referred to as “employee contribution ratings”) contain several features, no single one of which is solely responsible for their desirable attributes. Without limiting the scope of the present embodiments, their more prominent features will now be discussed below. After considering this discussion, and particularly after reading the section entitled “Detailed Description,” one will understand how the features of the present embodiments provide the advantages described here.

One aspect of the present embodiments includes the realization that decision makers (e.g., executives such as, but not limited to, CEOs, business leaders, etc.) need to be able to objectively measure employees' contribution and impact to the business. A business leader's visibility to their workforce impact and contribution may be made further opaque the larger the business grows in terms of employees. For example, a CEO may have a single layer of employees under direct supervision, allowing for direct line of sight to activities and/or contributions and therefore impact of each employee in the business. However, once the business adds a layer beneath the single layer, the CEO may lose line of sight and may be only made aware of any employee's contribution through the words of their own direct reports (e.g., a middle manager).

Another aspect of the present embodiments includes the realization that middle managers may view performance of supervised employees through their own preconceived judgements, perceptions, incentives, and/or motives. Whether such bias and/or business structures are positive or negative to a particular employee, they may lead to inaccurately reporting of the contribution of employees that they supervise. For example, a middle manager may connect with a particular employee that has similar experiences as the middle manager. In such a case, the middle manager may perceive the employee's contributions as more significant based on a perception bias. In another example, a middle manager may be threatened by their own employees rising above the middle manager. In this case, the middle manager may have an existential threatening reason to hide any significant contributions by their employees.

Another aspect of the present embodiments includes the realization that an employees' promotions, bonuses, recognitions, etc. may be based on an employee's own ability to articulate their value to the company in the form of their self-evaluation. Further, the employee may also have to then rely on their manager's own sales ability, self-interests, and priorities for the employee's recognition, reward, etc. Both of these steps may be rife with bias and subjectivity. In most organizations, there may be very little in the form of objective data that influences and compares one employee to another.

Another aspect of the present embodiments includes the realization that current evaluation methods may be made less effective and/or even worse when employees work remotely, whether that is fully remote or partially remote. Remote work may make an employee's value to the business hidden and even more dependent upon their relationship with their manager rather than the employee's actual contributions.

Another aspect of the present embodiments includes the realization that there are negative side effects of a disenfranchised employee. Typically, employees may first leave a bad boss rather than a bad job. Further, bad bosses ultimately accumulate subpar and disengaged employees over time. In addition, poor visibility into objective employee impact and contribution results in various negative side effects, including but not limited to, employee churn, a hard cost to the business to backfill and train a new proficient and impactful employee, lost productivity in the span of time that the business lacked a proficient and productive employee, and loss of historical knowledge of the business.

In a first aspect, a non-transitory machine readable storage medium is provided, the non-transitory machine readable storage medium storing a program comprising instructions that, when executed by at least one processor of a server, cause the server to perform operations including: receiving first employee action data associated with a first employee; receiving second employee action data associated with a second employee; and generating a plurality of groups, wherein the plurality of groups ranks employees based on the first employee action data and the second employee action data.

In an embodiment of the first aspect, the plurality of groups is generated using a machine learning engine.

In another embodiment of the first aspect, the machine learning engine is configured for a job function and the machine learning engine generates the plurality of groups based on the job function.

In another embodiment of the first aspect, the job function is revenue generated.

In another embodiment of the first aspect, the plurality of groups includes a Group A and a Group B, wherein the Group A includes employees that generated more revenue than employees in the Group B.

In another embodiment of the first aspect, the machine learning engine generates the plurality of groups based on recognizing phrases repeatedly used in the job function.

In another embodiment of the first aspect, the first employee action data and the second employee action data comprise email metadata.

In another embodiment of the first aspect, the first employee action data and the second employee action data comprise calendar metadata.

In another embodiment of the first aspect, the first employee action data and the second employee action data comprise meeting metadata.

In another embodiment of the first aspect, the first employee action data and the second employee action data comprise text metadata.

In another embodiment of the first aspect, the first employee action data and the second employee action data include chat metadata.

In another embodiment of the first aspect, the non-transitory computer readable storage medium further comprises instructions that, when executed by the at least one processor, further cause the server to receive participant data and generate the plurality of groups based on the participant data.

In another embodiment of the first aspect, the participant data comprises participant's seniority level, participant's job junction, and participant company metadata.

In another embodiment of the first aspect, the non-transitory computer readable storage medium further comprises instructions that, when executed by the at least one processor, further cause the server tor receive KPI metadata and generate the plurality of groups based on the KPI metadata.

In another embodiment of the first aspect, the KPI metadata comprises sales revenue.

In another embodiment of the first aspect, the first employee action data is received from a first employee device and the second employee action data is received from a second employee device.

In another embodiment of the first aspect, the first employee action data and the second employee action data are received from a 3^{rd} party service.

In another embodiment of the first aspect, the non-transitory computer readable storage medium further comprises instructions that, when executed by the at least one processor, further cause the server to receive first user data and second user data and generate the plurality of groups based on the first user data and the second user data.

In another embodiment of the first aspect, the non-transitory computer readable storage medium further comprises instructions that, when executed by the at least one processor, further cause the server to generate an impact score and generate the plurality of groups based on the impact score.

In another embodiment of the first aspect, the non-transitory computer readable storage medium further comprises instructions that, when executed by the at least one processor, further cause the server to generate a Sales Performance Accelerator (SPA) report, wherein the SPA report provides differences in employee action data between the plurality of groups.

### BRIEF DESCRIPTION OF THE DRAWINGS

FIG. 1 is a system diagram illustrating employee (EE) contribution in accordance with an embodiment of the invention.

FIG. 2 is a diagram illustrating contribution rating using machine learning in accordance with an embodiment of the invention.

FIG. 3 is a diagram illustrating a database architecture for capturing email metadata in accordance with an embodiment of the invention.

FIG. 4 is a block diagram illustrating a first EE device in accordance with an embodiment of the invention.

FIG. 5 is a block diagram illustrating a second EE device in accordance with an embodiment of the invention.

FIG. 6 is a block diagram illustrating a rating server in accordance with an embodiment of the invention.

FIG. 7 is a flowchart illustrating a process for capturing first EE action data in accordance with an embodiment of the invention.

FIG. 8 is a flowchart illustrating a process for capturing second EE action data in accordance with an embodiment of the invention.

FIG. 9 is a flowchart illustrating a process for EE contribution rating in accordance with an embodiment of the invention.

FIG. 10 is a flowchart illustrating a process for processing and analyzing EE action data using machine learning in accordance with an embodiment of the invention.

FIG. 11 is a diagram illustrating groups in accordance with an embodiment of the invention.

FIG. 12 is a flowchart illustrating another process for capturing first EE action data in accordance with an embodiment of the invention.

FIG. 13 is a flowchart illustrating another process for capturing second EE action data in accordance with an embodiment of the invention.

FIG. 14 is a diagram illustrating an opportunity engagement radar (OER) in accordance with an embodiment of the invention.

FIG. 15 is a diagram illustrating a sales performance accelerator (SPA) process in accordance with an embodiment of the invention.

FIG. 16 is a diagram illustrating an opportunity engagement progression in accordance with an embodiment of the invention.

### DETAILED DESCRIPTION OF THE DRAWINGS

The following detailed description describes the present embodiments with reference to the drawings. In the drawings, reference numbers label elements of the present embodiments. These reference numbers are reproduced below in connection with the discussion of the corresponding drawing features.

Turning now to the drawings, systems and methods for contribution ratings (may be referred to collectively as “contribution rating systems”) in accordance with embodiments of the invention are disclosed. In many embodiments, contribution rating systems may obtain and analyze employee actions to provide a deeper understanding of employee contribution and impact. For example, contribution rating systems may include capturing employee action data and analyzing such data to generate groupings of employees based on their relative contribution and/or impact to a particular function (may also be referred to as a “job function”), as further described below. In some embodiments, employee action data may be analyzed for various metrics, as further described below. For example, employee emails may be one employee action that may be utilized. In some embodiments, emails may be analyzed for various metrics such as, but not limited to, sentiment of each email sent, the recipients (may also be referred to as “participants”) who were sent the email, if the recipient sent a response, and the quality and/or sentiment of the original message and its response. In some embodiments, any text within the system may be used for sentiment analysis, as further described below. For example, text may be generated by an employee performing any job-related action (e.g., email, text, etc.). Further, text may be generated by converting data (e.g., voice) to text by the contribution rating system and/or a 3^{rd} party service. In addition, text may be generated by describing one form of data (e.g., video) and rendering the description to text. By processing and/or analyzing employee actions, the contribution rating systems may add color to the simple activity metric. Business leaders may use this objective data to compare employees amongst each other and understand the behavior they want to model.

In various embodiments, contribution rating systems may utilize supervised or unsupervised learning (e.g., machine learning engines) to process and/or analyze various data sets to group strong contributing employees from other less impactful employees, as further described below. For example, contribution rating systems may provide as input employee activity metrics such as, but not limited to, email metadata, calendar metadata, meeting metadata, text metadata, chat metadata, and/or job key performance indicators (KPI) metadata to a machine learning engine. In some embodiments, the contribution rating systems may also provide participant data such as, but not limited to, participant seniority level, participant job junctions, and/or participant company metadata. In several embodiments, the contribution ratings systems may analyze and process such data sets for each employee based on one or more functions and provide as an output grouping of employees based on the analysis of each individual employee's data sets, as further described below. For example, the top 20% of employees may be grouped in an “A” group, the next 40% may be grouped in a “B” group, and the bottom 40% may be grouped in a “C” group. In various embodiments, the number of groups, the size of any particular group, the reference function for grouping, etc. may be configured based on the needs of any specific application in accordance with embodiments of the invention. Systems for contribution ratings in accordance with embodiments of the invention are further described below.

### Systems for Contribution Ratings

By measuring the communication of each employee and comparing the metrics among all employees in a given function, business leaders may understand not only which employees are active, engaged, and/or productive, but they may also take action to recognize and reward contributing and impactful employees. However, simple activity alone may not be enough. For example, number of emails sent by an employee, may not be a good enough measure of contribution and impact. Further, activity alone may not be enough to measure how good an employee is versus another employee. Activity may be a good metric to measure engagement, but the leader should use more data to measure contribution.

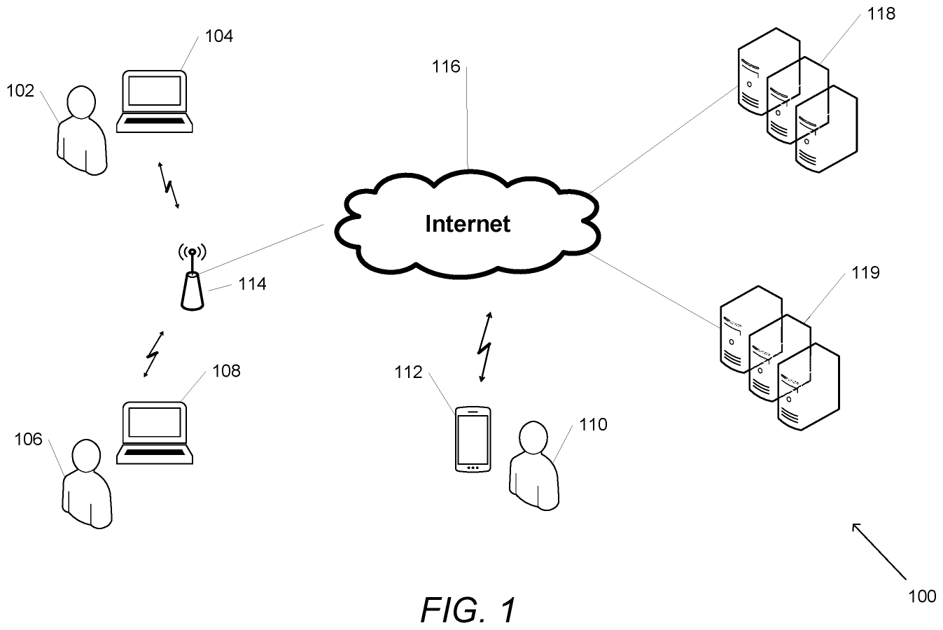

A system diagram illustrating employee (EE) contribution ratings in accordance with an embodiment of the invention is shown in FIG. 1. A contribution rating system 100 may include a first employee 102 on a first EE device 104 and a second employee 106 on a second EE device 108. In various embodiments, the system 100 may also include additional employees on additional EE devices, such as, but not limited to, a third employee 110 on a third EE device 112. In various embodiments, the system 100 may include any number of employees each having their own EE device. In some embodiments, one or more employees may share a single EE device. For example, an EE device may be configured for use by multiple employees by allowing each employee to separately log into and use the EE device. In such embodiments, the EE device may be configured such that each employee's use of the EE device may be tracked, monitored, and/or configured as a separate account either virtually and/or physically. In various embodiments, the first employee 102, the second employee 106, the third employee 110, and any other number of employees may be employees of a common business. In many embodiments, the EE device(s) 104, 108, 112 may include various electronic devices that may allow a user to perform actions related to their employment, as further described below. For example, the EE device(s) 104, 108, 112 may include but not limited to, a desktop computer, a laptop computer, a tablet computer, a smart phone, etc.

In reference to FIG. 1, the EE devices 104, 108, 112 may be connected to and have access to the Internet 116 in a manner known to one of ordinary skill in the art. For example, the EE devices 104, 108, 112 may access the Internet 116 using a variety of methods such as, but not limited to, by using a modem and/or router (and/or using a wireless access point). For example, the first EE device 104 and the second EE device 108 may access the Internet 116 via a wireless access point 114, such as, but not limited to, Wi-Fi. Further, the third EE device 112 may access the Internet 116 using a cellular network. In some embodiments, the EE devices 104, 108, 112 may have dedicated access to the Internet 116 while an employee is performing job-related actions. In other embodiments, the EE devices 104, 108, 112 may have access to the Internet 116 at some time after the employee has performed job-related actions.

In further reference to FIG. 1, the first, second, and/or third employees (may also be referred as “users”) 102, 106, 110, may utilize their EE device(s) 104, 108, 112, respectively, in performing action such as, but not limited to, sending and receiving emails, calendaring meetings, conducting meetings (e.g., audio/video conferencing), text messaging, chatting (e.g., audio calls), etc. In some embodiments, the EE device(s) 104, 108, 112 may include a graphic user interface (“GUI”) that allows the employee to perform such actions. In some embodiments, the EE device(s) 104, 108, 112, may include one or more microphones for receiving voice inputs from the employees 102, 106, 110, respectively, as further described below. In some embodiments, the EE device(s) 104, 108, 112, may include one or more cameras for capture image data, as further described below. In some embodiments, the EE device(s) 104, 108, 112, may be configured to capture data related to the employee's actions (may also be referred to as “EE action data”) and transmit EE action data to one or more rating server(s) 118, as further described below. In some embodiments, the rating server(s) 118 may be configured to monitor the EE device(s) 104, 108, 112 and capture the EE action data. In some embodiments, the EE device(s) 104, 108, 112, may be monitored using methods known to one of skill in the art. For example, in some embodiments, the EE device(s) 104, 108, 112 may be monitored as part of a private network where action on the private network are monitored. In some embodiments, the EE device(s) 104, 108, 112 may be monitored using one or more software applications on the EE device(s) 104, 108, 112.

In further reference to FIG. 1, in many embodiments, the employees 102, 106, 110, may perform actions via a 3^{rd} party system (e.g., 3^{rd} party server(s) 119). For example, the 3^{rd} party server(s) 119 may be hosted by one or more 3^{rd} party providers that may provide various functionalities. In some embodiments, such 3^{rd} party provider(s) may provide software as a service (SaaS) utilizing the cloud. For example, the 3^{rd} party server(s) 119 may provide for applications such as, but not limited to, email/calendaring systems (e.g., Google Gmail, Google Workspace, Microsoft Outlook, Microsoft 365, etc.), meeting systems (e.g., Webex, Zoom, etc.), messaging systems, and/or any other job-related related functionalities, as further described below. In some embodiments, a single 3^{rd} party service provider may provide a suite of applications. In some embodiments, a plurality of 3^{rd} party service providers may provide certain applications while other 3^{rd} party service providers may provide certain other applications. In various embodiments, the employees 102, 106, 110, using EE device(s) 104, 108, 112 or any other device(s), may communicate with the 3^{rd} party server(s) 119 via the internet 116.

In further reference to FIG. 1, the EE device(s) 104, 108, 112 may also provide user data such as, but not limited to, location data (e.g., Global Positioning System (GPS) data), to the rating server(s) 118. In such embodiments, the rating server(s) 118 may use the user data in analyzing and/or processing EE action data, as further described below. For example, due to the shift to remote working, location data may be another input in evaluating an employee's contribution and impact.

As described herein, EE action data may include various data related to job functions. For example, EE action data may include email metadata, calendar metadata, meeting metadata, text metadata, chat metadata, etc. In many embodiments, EE action data may include the action performed and/or metadata related to the action performed. For example, email metadata may include the email received/sent and any additional information related to the email, as further described below. Likewise, calendar metadata may include the calendar event and any additional information related to the calendar event. Further, meeting metadata may include a recording of the meeting and any additional information related to the meeting. Furthermore, text metadata may include the text message and any additional information related to the text message. Moreover, chat metadata may include the chat and any additional information related to the chat. In addition, EE action data may comprise text data (may also be referred to as “text input”), audio data (may also be referred to as “audio input”), and/or image data (may also be referred to as “image input” or “video input”), as further described below.

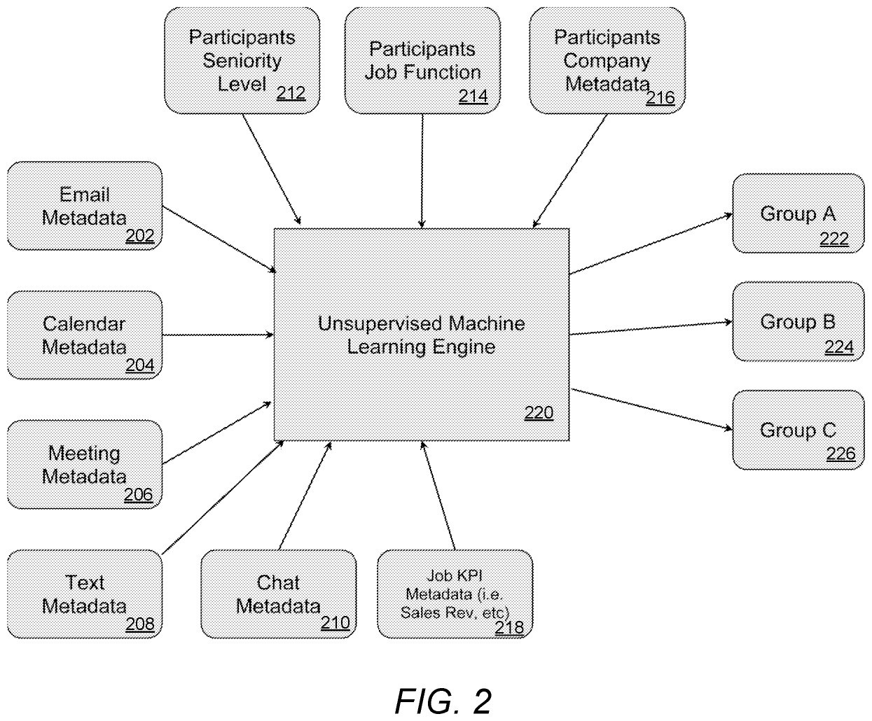

A diagram illustrating contribution rating using machine learning in accordance with an embodiment of the invention is shown in FIG. 2. The diagram illustrates that data (e.g., EE action data, participant data, job KPI metadata) may be collected (e.g., captured) and inputted to an unsupervised machine learning engine 220 (may also be referred to as “ML engine”). For example, the EE action data may include, but is not limited to, email metadata 202, calendar metadata 204, meeting metadata 206, text metadata 208, and/or chat metadata 210. In some embodiments, participant data may include, but is not limited to, participant's seniority level 212, participant's job function 214, and/or participant's company metadata 216. In some embodiments, job KPI metadata may include job KPI metadata 218 such as, but not limited to, sales revenue, etc.

In further reference to FIG. 2, the ML engine 220 may categorize and group the input data into a finite set. For example, groups A 222, B 224, and C 226 are illustrated, but this could be any number of groups n defined by the job function (for example, Sales might include 4 groups whereas Product Management might include 5 groups, etc.) or by the business unit. Each group on the right side of FIG. 2 may vary mainly in their contribution and/or impact to the business.

In reference to FIG. 2, the ML engine 220 may be used to identify patterns and make predictions based on data sets such as, but not limited to EE action data, participant data, job KPI metadata, etc. For example, in some embodiments, the ML engine 220 may receive email metadata 202, calendar metadata 204, meeting metadata 206, text metadata 208, and/or chat metadata 210, participant's seniority level 212, participant's job function 214, and/or participant's company metadata 216, and/or job KPI metadata 218 and output at least one group (e.g., Group A 222, Group B 224, and/or Group C 226). In some embodiments, the ML engine 220 may be used to build and train ML learning models that continue to improve predictions as more data sets are provided to the ML engine 220. In some embodiments, the ML engine 220 may be used to predict and/or assign which group an employee may be classified based their EE action data. In some embodiments, the ML engine 220 may be used to predict and/or assign an employee to a group, where the groups may change depending on the job function. One of ordinary skill in the art would appreciate that the ML engine 220 may be implemented in various manners. For example, the ML engine 220 may be hosted in the cloud, the ML engine 220 may be implemented by one or more servers, the ML engine 220 may be implemented in a standalone hardware device (e.g., server, etc.), the ML engine 220 may be implemented as code to run, etc. Further, although the ML engine 220 is described as unsupervised, the ML engine 220 may be implemented with supervision or any other control as appropriate to the requirements of a specific application in accordance with embodiments of the invention.

In some embodiments, metadata in each illustrated box may refer to all the attributes for that box. For example, email metadata 202 may include, but is not be limited to:
1. Sender Email Address
2. Sender Domain
3. Sender Seniority Level (taken from company organization and/or customer relationship management “CRM”)
4. Recipient Count

15. Recipient Domains
6. Recipient Job Function (e.g., product management, sales, marketing, engineering, etc.)
7. Recipient Seniority Levels
8. Attachments
9. Time Sent
10. Sentiment Analysis of email Body (e.g., significant and relevant vs “thank you for sending that” which may not be as impactful)
11. Character count of subject
12. Character count of body
13. Engagement (response from recipients)
14. CC recipients with same attributes as 4-7 listed above
15. BCC recipients

Further, calendar metadata 204 may include, but is not limited to:
1. Organizer company, email address, domain, title, seniority level, job function
2. Invitee company, email address, domain, title, seniority level, job function, acceptance status
3. Calendar Body Sentiment Analysis for event
   a. Is objective/goal/target identified?
   b. Is there an agenda?
   c. Attachment?

In addition, meeting metadata 206 may include, but is not limited to:
1. Organizer company, email address, domain, title, seniority level, job function, speak time
2. Attendee company, email address, domain, title, seniority level, job function, speak time
3. Length of conference
4. Number of external participants
5. Number of internal participants
6. Number of confirmed invitees

The above attributes are merely examples of email metadata 202, calendar metadata 204, and meeting metadata 206. In many embodiments contribution rating systems may capture similar and relevant metadata for text 208, chat 210, job KPI 218, and various other forms of EE action data.

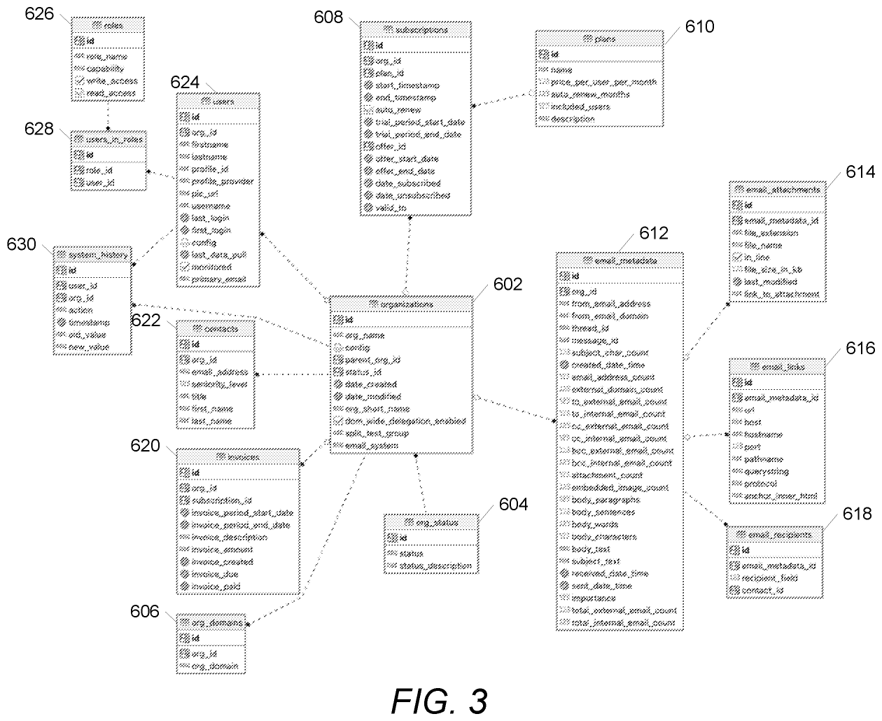

Business leaders may then take the groups (e.g., group A 222, group B 224, group C 226) and look back through the data categorizations for the activity and behaviors of employees in each group. This analysis may provide leaders with insight on communication differences between the group members. For example, group A 222 who may include the highest performing employees may differ from those in group B 224 by frequency of emails sent, the recipient seniority levels, job functions of recipients, and more. Such measurements may not only provide leaders with a snapshot in time of comparison, but also leaders may be able to see objective employee contribution (not just performance) over time. A diagram illustrating a database architecture for capturing email metadata 202 in accordance with an embodiment of the invention is shown in FIG. 3. The database architecture may include various tables, such as, but not limited to, an organization table 602, organization status table 604, organization domains 606, subscriptions 608, and plans 610. Further, the database architecture may include an invoices table 620, contacts table 622, users table 624, roles 626, users_in_roles table 628, and a system_history table 630. In addition, the database architecture may also include an email_metadata table 612, email_attachments table 614, email_links table 616, and email_recipients table 618.

In reference to FIG. 3, the database architecture shows how email data may be captured. For example, the contacts table 622 may be used to store titles and seniority levels (e.g., directors, managers, VPs, etc.) which may be used in the emails table as “from_seniority_level” and “seniority_level” (not shown above) in the email_recipients table 618. In some embodiments, seniority level may be an integer value to represent where the contact is in the organization's hierarchy. For example, an entry level position may be 1 whereas the most senior employee (e.g., CEO) may be 20 with 18 levels in between. In many embodiments, such representation may vary based on the business. For example, some business' may have 20 levels of seniority while others only have 10, etc.

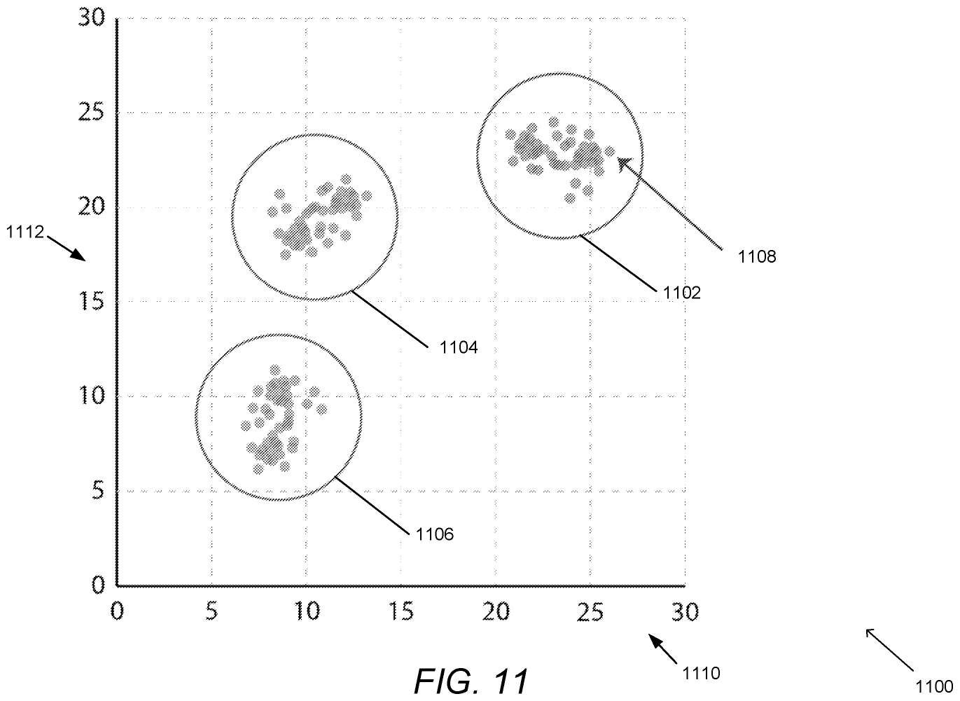

A diagram illustrating groups in accordance with an embodiment of the invention is shown in FIG. 11. The diagram may include clustering for Groups A 1102, B 1104, and C 1106. In various embodiments, Group A 1102 may indicate “top contributing,” Group B 1104 may indicate “medium contributing,” and Group C 1106 may indicate “lease contributing.” In many embodiments, each filled circle may represent an employee and their respective contribution. When plotted on the diagram, the filled circles may be grouped into one or more groups (e.g., Group A 1102, Group B 1104, Group C 1106, etc.). For example, the arrow points 1108 to an example of an employee (e.g., “John Smith”). In this example, John Smith may be generating the most revenue as a sales rep. Using this diagram, the other filled circles near John Smith may indicate behavior similar to John Smith. However, such other employees may not be generating as much revenue as John Smith. This may indicate that there are other reasons that those other sales reps are not generating the same amount of revenue as John Smith because their grouping may be very similar (or the same) to John Smith which indicates that they are behaving very similar to John Smith. In some embodiments, the groups may allow for eliminating employee behavior and call for additional factors beyond activity to be considered for reasons for success.

In reference to FIG. 11, the axes may be set and changed based on the role and/or function of the employee. For example, the x-axis 1110 may be a combination of activity and the y-axis 1112 may be an impact (e.g., revenue generated). In various embodiments, the x-axis 1110 and/or the y-axis 1112 may be represented by numeric values as appropriate to the requirements of the specific application.

Although specific contribution rating systems including specific devices are illustrated in FIGS. 1-3 and 11, any number of systems and devices (and any number of employees) as appropriate to the requirements of a specific application may be utilized in accordance with embodiments of the invention. In many embodiments, the accuracy of the contribution ratings may become higher as more employees are part of the contribution rating systems and as the ML engine is exposed to more inputs. Further, while the contribution rating systems illustrate exemplary devices, a person skilled in the art would recognize that the invention is not limited to the devices shown and may include additional types of devices. EE devices and servers for contribution rating systems in accordance with embodiments of the invention are discussed further below.

### Employee Devices and Servers in Contribution Rating Systems

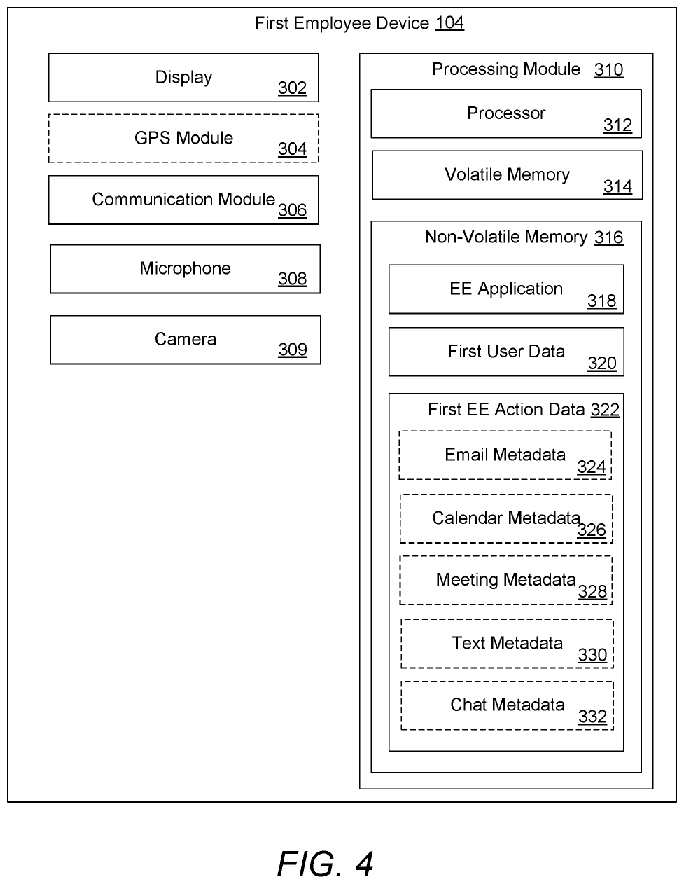

Various devices may be used in contribution rating systems. A block diagram illustrating a first employee (EE) device in accordance with an embodiment of the invention.is shown in FIG. 4. The first EE device 104 may include a display 302, a communication module 306, a microphone 308, and a camera 309. In some embodiments, the display 302, the microphone 308, and/or camera 309 may be separate standalone devices from the first EE device 104. For example, in some embodiments, the first EE device 104 may be a desktop computer configured to connect to a display 302, microphone 308, and/or camera 309. In some embodiments, the first EE device 104 may be a laptop computer that includes a built-in display 302, microphone 308, and/or camera 309. In some embodiments, the microphone 308 may capture audio input (e.g., voice input) and the camera 309 may capture image input (e.g., video input), as further described below. Further, in some embodiments, the first EE device 104 may include a GPS module 304 that may be configured to track and store first user data 320 (e.g., location data) associated with the first EE device 104.

In reference to FIG. 4, the first EE device 104 may also include a processing module 310 that may include a processor 312, a volatile memory 314, and a non-volatile memory 316. In various embodiments, the non-volatile memory 316 may include an EE application 318 that allows the first EE device 104 to capture first EE action data 322, as further described below. For example, the first EE device 104 may be configured to capture and store first EE action data 322 such as, but not limited to, email metadata 324, calendar metadata 326, meeting metadata 328, text metadata 330, and/or chat metadata 322, as further described below. Further, the non-volatile memory 316 may be configured to capture and store first user data 320 such as, but not limited to, location data and any other data related to a first employee. For example, the first user data 320 may include the first employee's personnel data, personal identification information, login information, etc. In some embodiments, the EE application 318 may provide for speech-to-text-conversion capabilities. In some embodiments, the EE application 318 may provide for interfaces, uploads, downloads, and/or data functionality to support contribution rating systems. In several embodiments, the first EE device 104 may transmit, using the communication module 306, the first EE action data 322 and/or the first user data 320 to rating server(s) 118 for analysis and/or processing, as further described below.

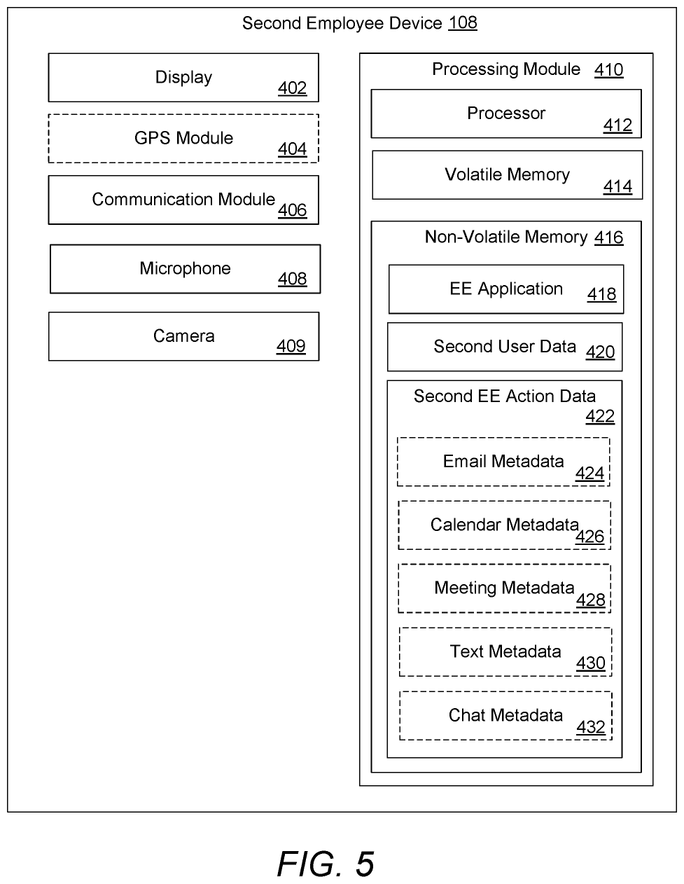

A block diagram illustrating a second EE device in accordance with an embodiment of the invention is shown in FIG. 5. The second EE device 108 may include a display 402, a communication module 406, a microphone 408, and a camera 409. In some embodiments, the display 402, the microphone 408, and/or camera 409 may be separate standalone devices from the second EE device 108. For example, in some embodiments, the second EE device 108 may be a desktop computer configured to connect to a display 402, microphone 408, and/or camera 409. In some embodiments, the second EE device 108 may be a laptop computer that includes a built-in display 402, microphone 408, and/or camera 409. In some embodiments, the microphone 408 may capture audio input (e.g., voice input) and the camera 409 may capture image input (e.g., video input), as further described below. Further, in some embodiments, the second EE device 108 may include a GPS module 404 that may be configured to track and store first user data 420 (e.g., location data) associated with the second EE device 108.

In reference to FIG. 5, the second EE device 108 may also include a processing module 410 that may include a processor 412, a volatile memory 414, and a non-volatile memory 416. In various embodiments, the non-volatile memory 416 may include an EE application 418 that allows the second EE device 108 to capture second EE action data 422, as further described below. For example, the second EE device 108 may be configured to capture and store second EE action data 422 such as, but not limited to, email metadata 424, calendar metadata 426, meeting metadata 428, text metadata 430, and/or chat metadata 422, as further described below. Further, the non-volatile memory 416 may be configured to capture and store first user data 420 such as, but not limited to, location data and any other data related to a first employee. For example, the second user data 420 may include the second employee's personnel data, personal identification information, login information, etc. In some embodiments, the EE application 418 may provide for speech-to-text-conversion capabilities. In some embodiments, the EE application 418 may provide for interfaces, uploads, downloads, and/or data functionality to support contribution rating systems. In several embodiments, the second EE device 108 may transmit, using the communication module 406, the second EE action data 422 and/or the second user data 420 to rating server(s) 118 for analysis and/or processing, as further described below.

In reference to FIGS. 4-5, the various components including (but not limited to) the processing modules 310, 410 are represented by separate boxes. The graphical representations depicted in each of FIGS. 4-5 are merely examples and are not intended to indicate that any of the various components of the first EE device 104, and/or the second EE device 108 are necessarily physically separate from one another, although in some embodiments they might be. In some embodiments, however, the structure and/or functionality of any or all components of the first EE device 104 and/or second EE device 108 may be combined. In some embodiments, the processors 312, 412 may include, but is not limited to, any generic processing unit capable of performing computations. The volatile memories 314, 414 may include, but is not limited to, Randomly Accessed Memory (RAM) or another comparable form of rapid storage. Non-volatile memories 316, 416 may include, but are not limited to, any memory type that retains storage of data after powering down. In addition, in some embodiments, the communication modules 306, 406 may include their own processors, volatile memories, and/or non-volatile memories. In addition, the communication modules 306, 406 may comprise, but are not limited to, one or more transceivers and/or wireless antennas (not shown) configured to transmit and receive wireless signals such as (but not limited to) satellite, radio frequency (RF), Bluetooth or WIFI. In other embodiments, the communication modules 306, 406 may comprise (but are not limited to) one or more transceivers configured to transmit and receive wired signals.

Contribution rating systems may be implemented across various devices. These devices may each perform different tasks in different embodiments. For example, a server may receive employee action data, user data, participant data, and generate group data based on impact of each employee. In some embodiments, servers may receive such data directly from EE devices. In some embodiments, servers may “sit on the edge” and receive such data by monitoring communication to and from EE devices. In other embodiments, EE metadata may be pulled (e.g., by requesting and receiving) from 3^{rd} party systems prior to being processed by the rating server(s) 118. For example, Google's email service may store all email for all business' employees. The rating server(s) 118 may be configured to query Google's email service to gather email metadata and store it on the rating server(s) 118.

A block diagram illustrating rating server(s) 118 in accordance with an embodiment of the invention is shown in FIG. 5. The rating server(s) 118 may include a processing module 502 that comprises a processor 504, a volatile memory 506, network interface 508, and a non-volatile memory 510. In many embodiments, the non-volatile memory 510 may include a server application 512 that configures the processor 504 to process and analyze EE action data and generate groups 526 (may also be referred to as “group data”) based on an employee's contribution and impact, as further described below. The rating server(s) 118 may also be configured to receive, from the first EE device 104, first user data 320, and/or first EE action data 322 which may include, but is not limited to, email metadata 324, calendar metadata 326, meeting data 328, text metadata 330, and/or chat metadata 332. Further, the rating server(s) 118 may also be configured to receive, from the second EE device 108, second user data 420, and/or second EE action data 422 which may include, but is not limited to, email metadata 424, calendar metadata 426, meeting data 428, text metadata 430, and/or chat metadata 432. In many embodiments, the rating server(s) 118 may be configured to receive, from various additional EE devices, EE action data and/or user data. In addition, the rating server(s) 118 may be configured to receive, job KPI metadata 514 and/or participant data 516 including, but not limited to, participant seniority level 518, participant job function 520, and/or participant company metadata 522, as further described below.

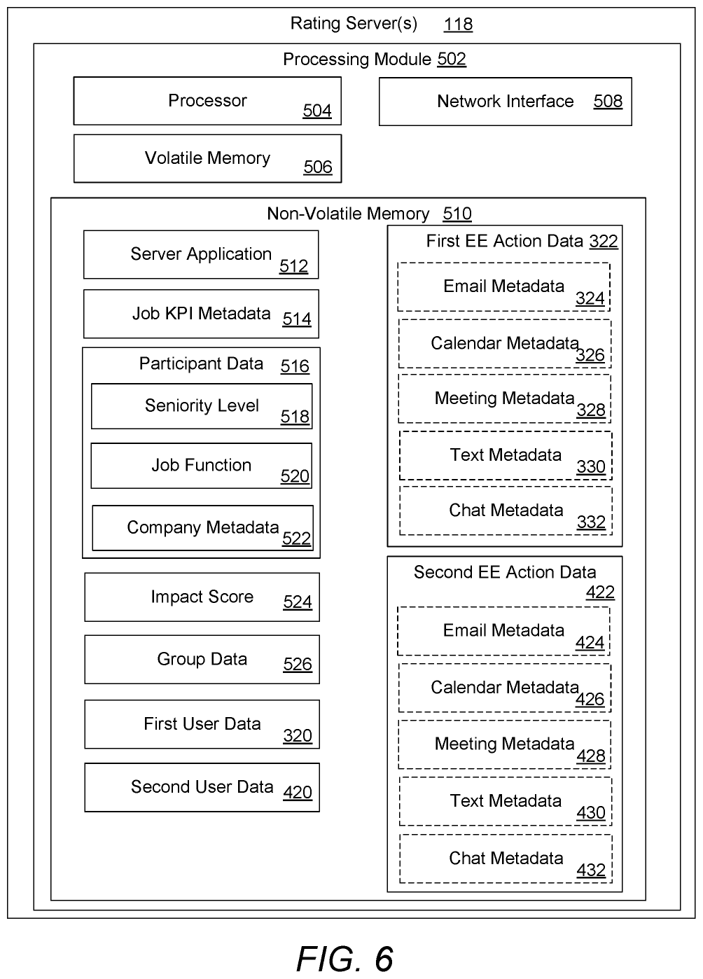

In reference to FIG. 6, the rating server(s) 118 may be configured to generate group data 526 using the received data from the first EE device 104 and second EE device 108 (and other EE device(s) such as, but not limited to, the third EE device 112). For example, the rating server(s) 118 may utilize various processes, such as, but not limited to, machine learning processes for using the first EE action data 322 and the second EE action data 420 (or any additional data) to generate group data 526, as further described herein. In some embodiments, the rating server(s) 118 may generate an impact score 524 that may be utilized in generating group data 526, as further described below. In many embodiments, the impact score 524 may comprise processed results for each employee in relation to a particular job function. For example, each employee (e.g., the first employee 102, second employee 106, third employee 110, etc.) may be associated with an impact score 524 for a particular job function based on processed results of their respective EE action data and/or any other data (e.g., job KPI metadata, participant data, user data, etc.) available to the rating server(s) 118. In many embodiments, the group data 526 may be number-based and/or include additional non-number-based information relevant and be pertinent to a description of a contribution ratings, as further described below.

In further reference to FIG. 6, the various components, including (but not limited to) the processing module 502, are represented by separate boxes. The graphical representations depicted in FIG. 6 are merely examples and are not intended to indicate that any of the various components of the rating server(s) 118 are necessarily physically separate from one another, although in some embodiments they might be. In some embodiments, however, the structure and/or functionality of any or all components of the rating server(s) 118 may be combined. In addition, in some embodiments the network interface 508 may include its own processor, volatile memory, and/or non-volatile memory. In addition, the network interface 508 may comprise, but is not limited to, one or more transceivers and/or wireless antennas (not shown) configured to transmit and receive wireless signals such as (but not limited to) satellite, radio frequency (RF), Bluetooth or WIFI. In other embodiments, the network interface 508 may comprise (but is not limited to) one or more transceivers configured to transmit and receive wired signals.

In reference to FIG. 6, the rating server(s) 118 may be implemented as an ML engine, as further described above. For example, the rating server 118 may be implemented as the ML engine 220. In some embodiments, the rating server 118 may be implemented to include the ML engine 220 as part (either physically or by code) of the rating server 118. In some embodiments, the rating server 118 may be implemented without the ML engine 220 and, in such embodiments, the rating server 118 may be in communication with the ML engine 220 in a manner known to one of skill in the art.

Although specific EE devices and servers for contribution rating systems are discussed above with respect to FIGS. 4-6, any of a variety of EE devices and servers as appropriate to the requirements of a specific application may be utilized in accordance with embodiments of the invention. For example, the EE devices 104, 108, 112 may include additional sensor(s) that may be configured to capture information and metadata such as, but not limited to, a fingerprint scanner, a speedometer (for delivery drivers), etc. Further, the rating server(s) 118 may be implemented utilizing a SaaS implementation. For example, the rating server(s) 118 may be hosted in the cloud and distributed throughout multiple data centers with redundancy. In addition, the various functions of the rating server(s) 118 may be distinct and may be implemented by their own server. In some embodiments, the rating server(s) 118 may be deployed in multiple locations to maintain availability and performance. Moreover, the rating server(s) 118 may scale where there are multiple servers (e.g., email servers) processing metadata (e.g., email metadata) depending on the volume and rate of actions being processed (e.g., emails). Processes for capturing EE action data in accordance with embodiments of the invention are further described below.

### Processes for Capturing Employee Action Data

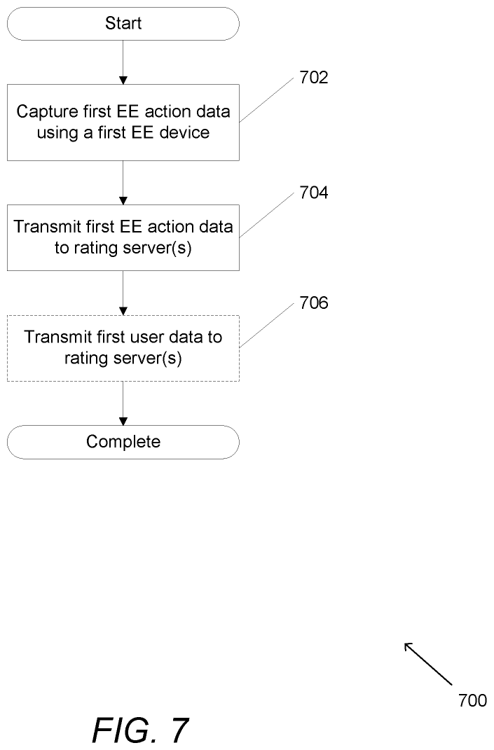

A flowchart illustrating a process for capturing first EE action data in accordance with an embodiment of the invention is shown in FIG. 7. In many embodiments, the EE application 318 may be downloaded onto the first EE device 104 and may run on the first EE device 104 using various methods known to one of ordinary skill in the art. In some embodiments, the EE application 318 may run in the background with or without direction from the first employee 102.

In reference to FIG. 7, the process 700 may include capturing (702) first EE action data 322 using the first EE device 104. In some embodiments, the EE application 318 may include job function capabilities such as, but not limited to, email, calendaring, meeting, text, and/or chat. In some embodiments, the EE application 318 may work in connection with various other applications or services running either natively or virtually on the first EE device 104 such as, but not limited to, email applications (e.g., Microsoft Outlook, Apple Mail, Google Gmail, etc.), calendaring applications (e.g., Microsoft Outlook, Apple Calendar, Google Calendar, etc.), meeting applications (e.g., Zoom, Apple Facetime, Google Meet, Skype, Cisco Webex, etc.), text messaging applications (e.g., Apple iMessage, Google Messages, etc.), chat applications (e.g., Slack, Google Hangouts, Microsoft Teams, etc.), etc. In several embodiments, in the course of performing their job duties (i.e., actions), the first EE device 104 may capture (702) the first EE action data 322, either directly or indirectly (via other applications or cloud-based services), as described herein. In various embodiments, the first EE action data 322 may include various types of inputs such as, but not limited to, voice inputs (e.g., audio), text inputs, image inputs (e.g., video), etc.

In reference to FIG. 7, the first EE device 104 may capture (702) image inputs using the camera 309 and voice inputs using the microphone 308. In various embodiments, the voice inputs may be converted to text data by the first EE device 104. In some embodiments, the voice inputs may be converted to text data by one or more servers (and utilized for analysis e.g., Sentiment Analysis, length of time spoken, who spoke, etc., as described herein). In some embodiments, the first EE device 104 may also capture (702) text inputs using a variety of input methods known to one of ordinary skill in the art. The process 700 may also include transmitting (704) the first EE action data 322, including but not limited to, email metadata 324, calendar metadata 326, meeting metadata 328, text metadata 330, and/or chat metadata 332 to a server (e.g., rating server(s) 118) using the communication module 306. The first EE action data 322 may be transmitted (704) to the server at various times. For example, the first EE device 104 may transmit (704) the first EE action data 322 when an Internet connection is available. In some embodiments, the first EE device 104 may transmit (704) the first EE action data 322 after the first employee has completed his or her job action and when the first EE logs off of the first EE device 104. In some embodiments, the first EE device 104 may transmit (704) the first EE action data 322 during performance of a job action by the first employee 102. In some embodiments, the first EE action data 322 may be transmitted (704) upon the first employee 102 providing a command to transmit the first EE action data 322 or the first employee 102 closing the EE application 318. In some embodiments, the process 700 may further include transmitting (706) the first user data 320 using the communication module 306. Similar to transmitting (704) the first EE action data 322, the first user data 320 may be transmitted (706) to one or more servers (e.g., rating server(s) 118) at various times, as described above.

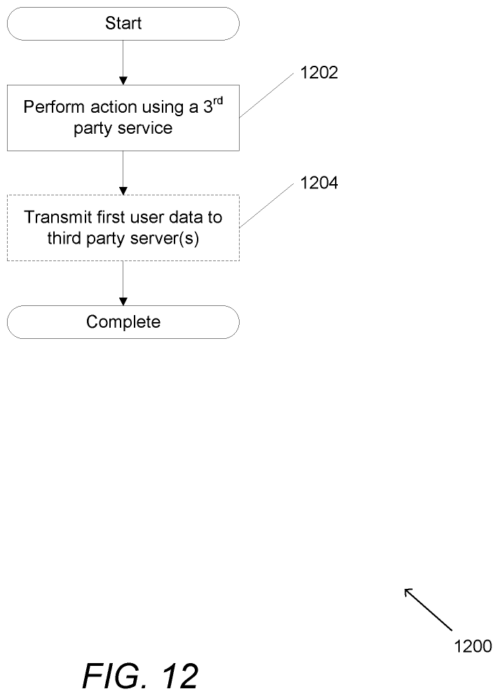

In some embodiments, some or all of the first EE action data 322 may be queried from a 3^{rd} party servicer (e.g., 3^{rd} party server(s) 119). A flowchart illustrating another process for capturing first EE action data in accordance with an embodiment of the invention is shown in FIG. 12. The process 1200 may include the first employee 102 performing (1202) job action data which is captured and saved by a 3^{rd} party service, as further described herein. In many embodiments, the 3^{rd} party service may be a SaaS provider hosted on the 3^{rd} party server(s) 119, as further described above. For example, the first employee 102 may send (1202) an email using Google Gmail in the course of performing their job. As further described below, Google's email server(s) 119 may store the first employee's 102 emails, which may be queried by the rating server(s) 118 to pull the email metadata 324. In this manner, the first EE action data 322 may be collected directly from the 3^{rd} party system(s) (e.g., 3^{rd} party server(s) 119) instead of from the first EE device 104. In addition, in some embodiments, the process 1200 may also include transmitting (1204) the first user data 320 to the 3^{rd} party server(s) 119 and/or to the rating server(s) 118.

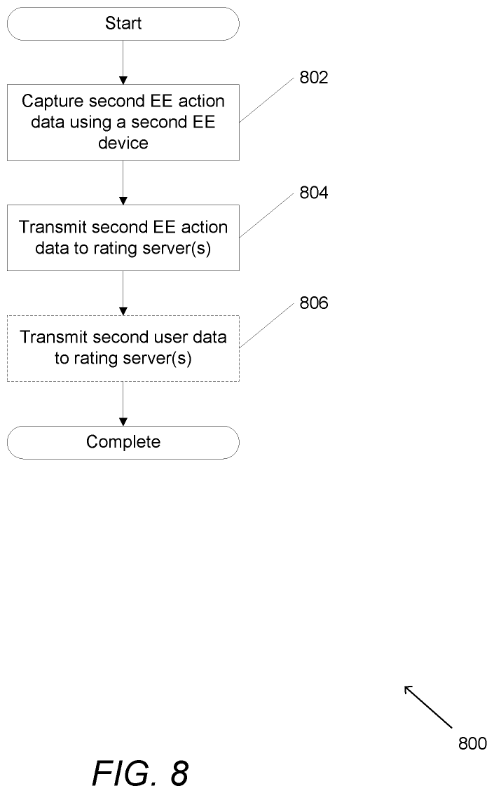

A flowchart illustrating a process for capturing second EE action data in accordance with an embodiment of the invention is shown in FIG. 8. In many embodiments, the EE application 418 may be downloaded onto the second EE device 108 and may run on the second EE device 108 using various methods known to one of ordinary skill in the art. In some embodiments, the EE application 418 may run in the background with or without direction from the second employee 106.

In reference to FIG. 8, the process 800 may include capturing (802) second EE action data 420 using the second EE device 108. In some embodiments, the EE application 418 may include job function capabilities such as, but not limited to, email, calendaring, meeting, text, and/or chat. In some embodiments, the EE application 418 may work in connection with various other applications running either natively or virtually on the second EE device 108, as further described above. In several embodiments, in the course of performing their job duties (i.e., actions), the second EE device 108 may capture (702) the second EE action data 422, either directly or indirectly (via other applications), as described above. In various embodiments, the second EE action data 422 may include various types of inputs such as, but not limited to, voice inputs (e.g., audio), text inputs, image inputs (e.g., video), etc.

In reference to FIG. 8, the second EE device 108 may capture (802) image inputs using the camera 409 and voice inputs using the microphone 408. In various embodiments, the voice inputs may be converted to text data by the second EE device 108. In some embodiments, the voice inputs may be converted to text data by one or more servers. In some embodiments, the second EE device 108 may also capture (802) text inputs using a variety of input methods known to one of ordinary skill in the art. The process 800 may also include transmitting (804) the second EE action data 422, including but not limited to, email metadata 424, calendar metadata 426, meeting metadata 428, text metadata 430, and/or chat metadata 432 to a server (e.g., rating server(s) 118) using the communication module 406. The first EE action data 422 may be transmitted (804) to the server at various times, as described above. In some embodiments, the process 800 may further include transmitting (806) the second user data 420 using the communication module 406. Similar to transmitting (804) the second EE action data 422, the second user data 420 may be transmitted (806) to one or more servers (e.g., rating server(s) 118) at various times, as described above.

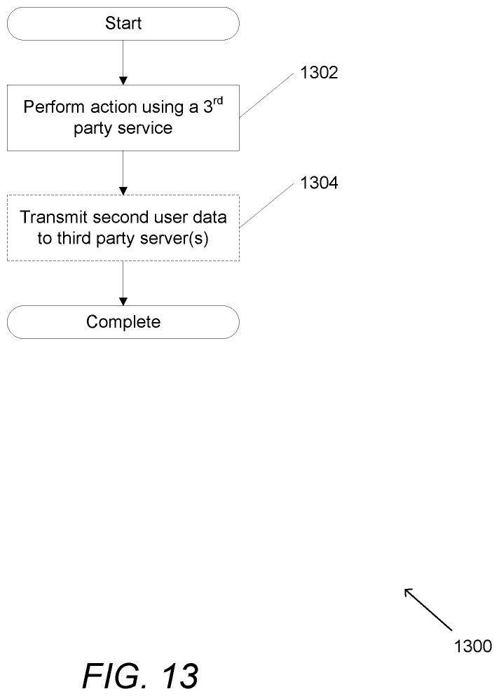

In some embodiments, some or all of the second EE action data 422 may be queried from a 3^{rd} party servicer (e.g., 3^{rd} party server(s) 119). A flowchart illustrating another process for capturing second EE action data in accordance with an embodiment of the invention is shown in FIG. 13. The process 1300 may include the second employee 106 performing (1302) job actions via a 3^{rd} party service, as further described herein. In many embodiments, the 3^{rd} party service may be a SaaS provider hosted on the 3^{rd} party server(s) 119, as further described above. For example, the second employee 106 may send (1302) an email using Google Gmail in the course of performing their job. As further described below, Google's email server(s) 119 may store the second employee's 106 emails, which may be queried by the rating server(s) 118 to pull the email meta data 424. In this manner, the second EE action data 422 may be collected directly from the 3^{rd} party system(s) (e.g., 3^{rd} party server(s) 119) instead of from the second EE device 108. In addition, in some embodiments, the process 1300 may also include transmitting (1304) the second user data 420 to the 3^{rd} party server(s) 119 and/or to the rating server(s) 118.

Although specific processes for capturing EE action data using EE devices are discussed above with respect to FIGS. 7-8 and 12-13, any of a variety of processes for capturing various data as appropriate to the requirements of a specific application may be utilized in accordance with embodiments of the invention. For example, in some embodiments, one or more servers (e.g., rating server(s) 118, 3^{rd} party server(s) 119), may perform the processes of capturing EE action data by monitoring communication by, and from, EE devices (e.g., first EE device 104, second EE device 108, third EE device 112, etc.). In some embodiments, the various steps may be performed in the cloud querying SaaS whether or not the EE devices are turned on or off, and/or during or after the employee has performed their actions. In various embodiments, EE action data may be measured and/or collected from either EE device(s) or 3^{rd} party server(s) 119 (or any other system that stores activity and communication information that could be converted to metadata). In some embodiments, the employees may perform actions via the 3^{rd} party server on their respective EE devices or using any other device. Processes for contribution ratings in accordance with embodiments of the invention are further described below.

### Processes for Contribution Ratings

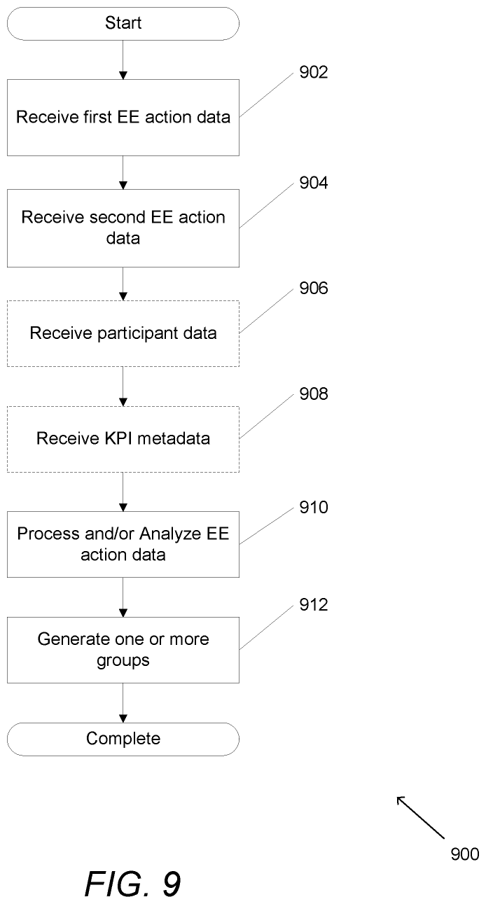

A flowchart illustrating a process for EE contribution rating in accordance with an embodiment of the invention is shown in FIG. 9. In many embodiments, the process 900 may be performed by the rating server(s) 118 and/or the ML engine 220. The process 900 may include receiving (902) first EE action data 322 using the network interface 508. In some embodiments, the first EE action data 322 may be received (902) from the first EE device 104. In some embodiments, the first EE action data 322 may be received (902) from the 3^{rd} party server(s) 119. For example, the 3^{rd} party server(s) 119 may be queried for the first EE action data 322. In some embodiments, the rating server(s) 118 and/or ML engine 220 (and/or an administrator) may transmit a request for the first EE action data 322 to the 3^{rd} party server(s) 119 and receive (902) the first EE action data 322 from the 3^{rd} party server(s) 119. In some embodiments, the rating server(s) 118 and/or ML engine 220 (and/or an administrator) may automatically receive (902) the first EE action data 322 from the 3^{rd} party server(s) 119 with or without transmitting a request. Further, in some embodiments, a portion of the first EE action data 322 may be received (902) from the 3^{rd} party server(s) 119 and a portion of the first EE action data 322 may be received (902) from the first EE device 104. In some embodiments, the process 900 may also include receiving the first user data 320 from the first EE device 104 and/or the 3^{rd} party server(s) 119 by the rating server(s) 118 and/or ML engine 220.

The process 900 may also include receiving (904) the second EE action data 422 using the network interface 508. In some embodiments, the second EE action data 422 may be received (904) from the second EE device 108. In some embodiments, the second EE action data 422 may be received (904) from the 3^{rd} party server(s) 119. For example, the 3^{rd} party server(s) 119 may be queried for the second EE action data 422. In some embodiments, the rating server(s) 118 and/or ML engine 220 (and/or an administrator) may transmit a request for the second EE action data 422 to the 3^{rd} party server(s) 119 and receive (904) the second EE action data 422 from the 3^{rd} party server(s) 119. In some embodiments, the rating server(s) 118 and/or ML engine 220 (and/or an administrator) may automatically receive (904) the second EE action data 422 from the 3^{rd} party server(s) 119 with or without request. Further, in some embodiments, a portion of the second EE action data 422 may be received (904) from the 3^{rd} party server(s) 119 and a portion of the second EE action data 422 may be received (904) from the second EE device 108. In some embodiments, the process 900 may further include receiving the second user data 420 from the second EE device 108 and/or the 3^{rd} party server(s) 119. In some embodiments, the process 900 also include receiving (906, 908) participant data 516 and/or KPI metadata 514 from the first EE device 104, the second EE device 108, 3^{rd} party server(s) 119, and/or any other device.

In reference to FIG. 9, the process 900 may also include processing and analyzing (910) EE action data (e.g., the first and/or second EE action data 322, 422). For example, in some embodiments, the rating server(s) 118 and/or ML engine 220 may process (910) the EE action data by converting the any audio data into text data. By converting the audio data to text data, the rating server(s) 118 and/or ML engine 220 may more readily handle the data and perform various processes on the data. In some embodiments, where the audio data comprises a plurality of voice inputs, the rating server(s) 118 may extract or identify between different voices by identifying the voice (e.g., voice recognition). Likewise, in some embodiments, particular phrases commonly used in a job junction may be recognized and learned by the rating server(s) 118 (e.g., via machine learning) and/or ML engine 220 for processing of the various data. In another example, the rating server(s) 118 and/or ML engine 220 may process (910) by associating the EE action data with EE user data. By associating the user and EE action, the rating server(s) 118 and/or ML engine 220 may more readily handle the data and perform various processes on the data. The process 900 may also include generating (912) one or more groups of employees for contribution ratings, as further described below.

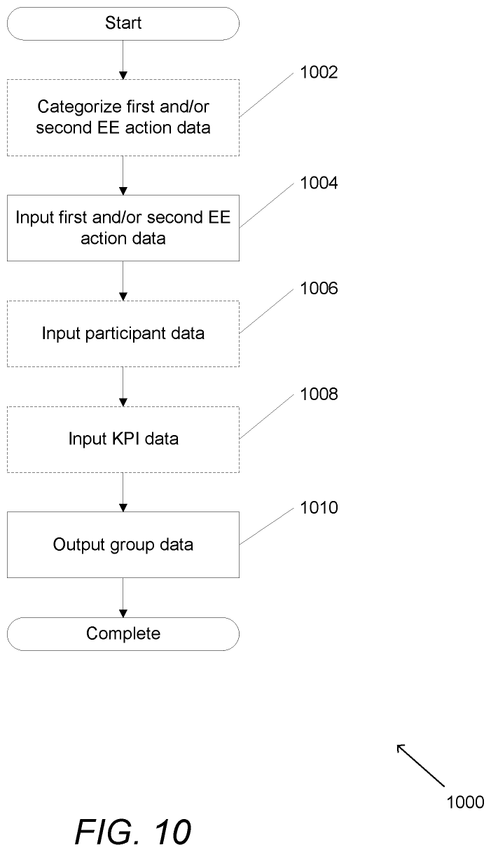

A flowchart illustrating a process 1000 for processing and analyzing (910) EE action data using machine learning in accordance with an embodiment of the invention is illustrated in FIG. 10. In various embodiments, the process 1000 may be performed by the rating server(s) 118 and/or the ML engine 220. In many embodiments, the process 1000 may be performed for each employee. In various embodiments, the process 1000 may be performed for a particular job function and/or position. In some embodiments, the process 1000 may include categorizing (1002) EE action data. For example, the rating server(s) 118 and/or the ML engine 220 may categorize (1002) the first EE action data 322 to smaller data sets such as, but not limited, email metadata 324, calendar metadata 326, meeting metadata 328, text metadata 330, chat metadata 332, etc. In some embodiments, the rating server(s) 118 may categorize (1002) the second EE action 422 to smaller data sets such as, but not limited to, email metadata 424, calendar metadata 426, meeting metadata 428, text metadata 430, chat meta data 432, etc. In some embodiments, the process 1000 may include inputting (1004) the EE action data (e.g., first EE action data 322 and/or second EE action data 422) into a machine learning engine (e.g., ML engine 220), as further described above. In some embodiments, the process 1000 may also include inputting (1006) participant data 516 such as, but not limited to, participant's seniority level 518, participant's job function 520, and/or participant's company metadata 522. In some embodiments, the process 1000 may further include inputting (1008) KPI metadata 514. The process 1000 may include outputting (1010) group data 526 that groups employees into groups based on their relative contribution ratings, as further described above. As described above, each group or set of groups may be defined for a particular job function. For example, the process 1000 may output different group data (e.g., employee group classifications) for the same input data based on the particular job function that the rating contribution processes (and/or the ML engine 220) is set for.

Although specific contribution rating processes are discussed above with respect to FIGS. 9-10, any of a variety of processes as appropriate to the requirements of a specific application may be utilized in accordance with embodiments of the invention. For example, in some embodiments, one or more servers (e.g., rating server(s) 118), may capture various data (e.g., EE action data, participant data, KPI metadata, etc.) directly by monitoring communication by, and from, EE devices (e.g., first EE device 104, second EE device 108, third EE device 112, etc.). Further, the process 1000 may be automated and the input of data (e.g., steps 1004, 1006 and/or 1008) may be repeated continuously or at predetermined intervals to continue to train and improve the ML engine 220's predictions. In various embodiments, the process 1000 may utilize the ML engine 220 to identify patterns and make prediction, as further described above. Sales performance considerations in accordance with embodiments of the invention are further described below.

### Sales Performance Considerations

Implementation of contribution rating systems may help members of a sales team reach their goals. As described above, there may be vast differences in performance between each member of a sales team. Further, many business owners may believe the way to overcome this spread is to increase quotas every year. However, this rising-tide approach often times may not work and frustrates sales teams.

Contribution rating systems in accordance with embodiments of the invention may allow employees (e.g., members of a sales team) work smarter, not harder. Rather than raising quotas, contribution rating systems may raise impactful sales behaviors. For example, the present embodiments may include delivery of data and analysis that unleashes individual potential. In various embodiments, the present embodiments may include the generation of a Sales Performance Accelerator (SPA) report, which may be utilized as a foundation for improving a team's performance. In some embodiments, the SPA report may include various information such as, but not limited to, impact score(s) 524 and group data 526 as further described above. In some embodiments, the SPA report may include various data, insights, and recommendations customized to a business. In some embodiments, the SPA report may also identify best practices of top sellers and provide a roadmap that every member of a sales team can follow to increase sales.

In many embodiments, utilization of better data (e.g., EE action data, user data, participant data, etc.) may lead to better salespeople and results. In many embodiments, a key component of the SPA report may be the contribution rating systems that feed an Opportunity Engagement Radar (OER), as further described below. As described herein, the contribution rating systems identify and highlight the contribution differences between top sellers and the rest of a team by automatically monitoring their communication behaviors for every sale. The present embodiments, analyze and categorize this data using wins and losses within a CRM to fingerprint top seller behaviors. The present embodiments then provide data-driven insights, analysis and personalized recommendations to help a supervisor coach each individual on ways to close more deals.

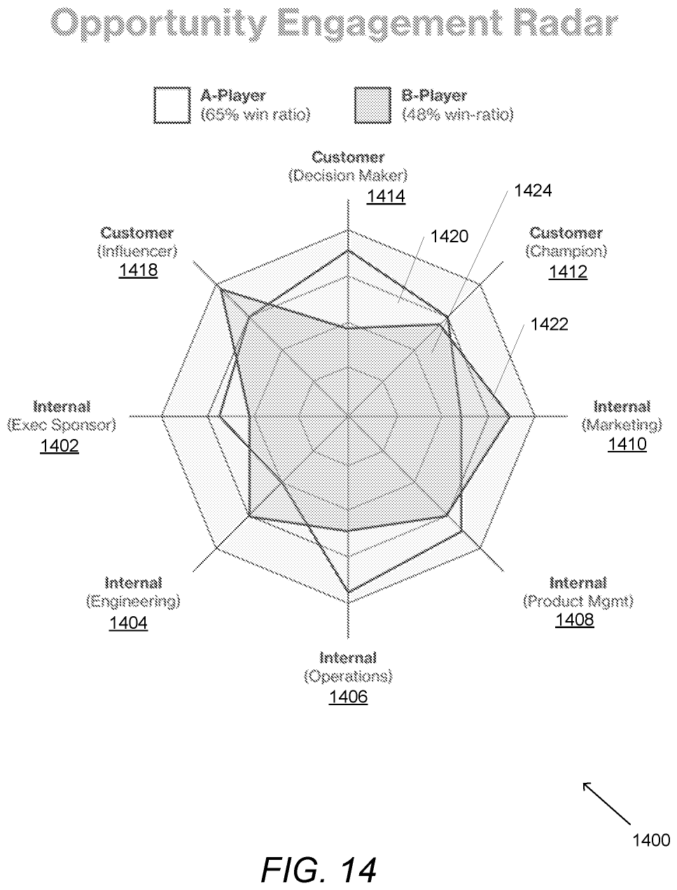

Traditional sales tools only track the quantity, not the quality of metrics. A diagram illustrating an opportunity engagement radar (OER) in accordance with an embodiment of the invention is shown in FIG. 14. The OER 1400 captures the quality of internal and external engagement. Knowing what your top people are doing and what the rest are not doing empowers a supervisor to replicate best practices for individual and team improvement. In reference to FIG. 14, the OER 1400 may identify an A-player 1420 and a B-player 1422. In some embodiments, the A-Player 1420 may be categorized as having some win-ratio and the B-Player 1422 may be categorized as having some lower win-ratio. For example, the A-Player 1420 may have a 65% win ratio and the B-Player 1422 may have a 48% win-ratio. The OER 1400 may visually present the A-Player 1420 and the B-Player 1422 on a graph based on the players' score relative to various metrics. For example, metrics may include internal metrics such as, but not limited to, executive sponsor 1402, engineering 1404, operations 1406, product management 1408, and/or marketing 1410. The metrics may also include customer metrics such as, but not limited to, champion 1412, decision maker 1414, and/or influencer 1418. In some embodiments, the A-player 1420 may be a group (e.g., a Group A) and/or the B-player 1422 may also be a group (e.g., a Group B) and the groups may be visually presented on an OER.

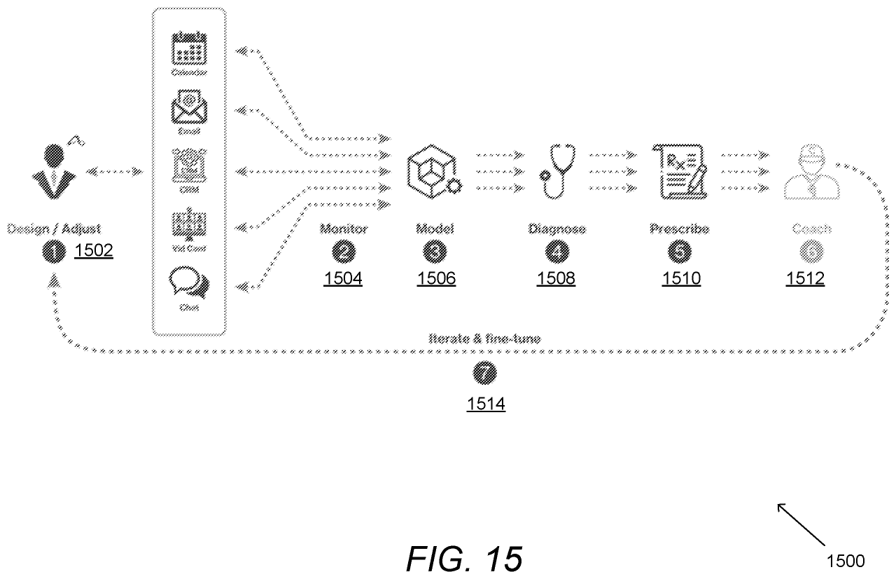

In various embodiments, an SPA report may automatically gather information from email, CRM, directory services and other enterprise applications. The present embodiments provide sales leaders with insights into sales rep communication behaviors, customer engagement beyond marketing leads, employee contribution, and more. A diagram illustrating a sales performance accelerator (SPA) process in accordance with an embodiment of the invention is shown in FIG. 15. The SPA process 1500 may include designing and (re)configuring (1502) what metrics to record and model to identify opportunities for improvement. The SPA process 1500 may also include monitoring (1504) electronic communications of an entire sales team. Further, the SPA process 1500 may also include identifying (1506) behaviors of each seller and determining the top behavioral models based on past sales performance. Moreover, the SPA process 1500 may also include comparing and diagnosing (1508) the differences between top reps (e.g., EEs) and the rest of the team. In some embodiments, each SPA report diagnosis may be specific to each rep. Further, the SPA process 1500 may include prescribing (1510) personalized coaching recommendations that can improve performance, saving time on sales development while improving sales performance. In addition, the SPA process 1500 may include sharing recommendation analysis with each rep to coach (1512) them toward improved sales efficacy. In some embodiments, the SPA process 1500 may include iterating and fine-tuning (1514) the OER to maximize performance by repeating any or all of the above steps. In some embodiments, the SPA process 1500 may end. In some embodiments, the SPA process 1500 may include generating an SPA report. For example, in some embodiments, the prescribing (1510) step may include generating an SPA report.

When implemented, a consultancy utilizing contribution rating systems may typically be 90 days and a client (e.g., a supervisor, sales manager, etc.) may receive an initial SPA report within the first 30 days. The consultancy may include receiving an updated SPA report for each sales rep every 30 days after the initial report. As described above, the contribution rating systems may identify the top rep behaviors and share this data with the client, which can be used for coaching. In some embodiments, each OER axis within the SPA report may be customized to reflect most important internal criteria and external business contacts. Further, SPA reports may be compared over time to show performance improvements and identify individuals needing additional training.

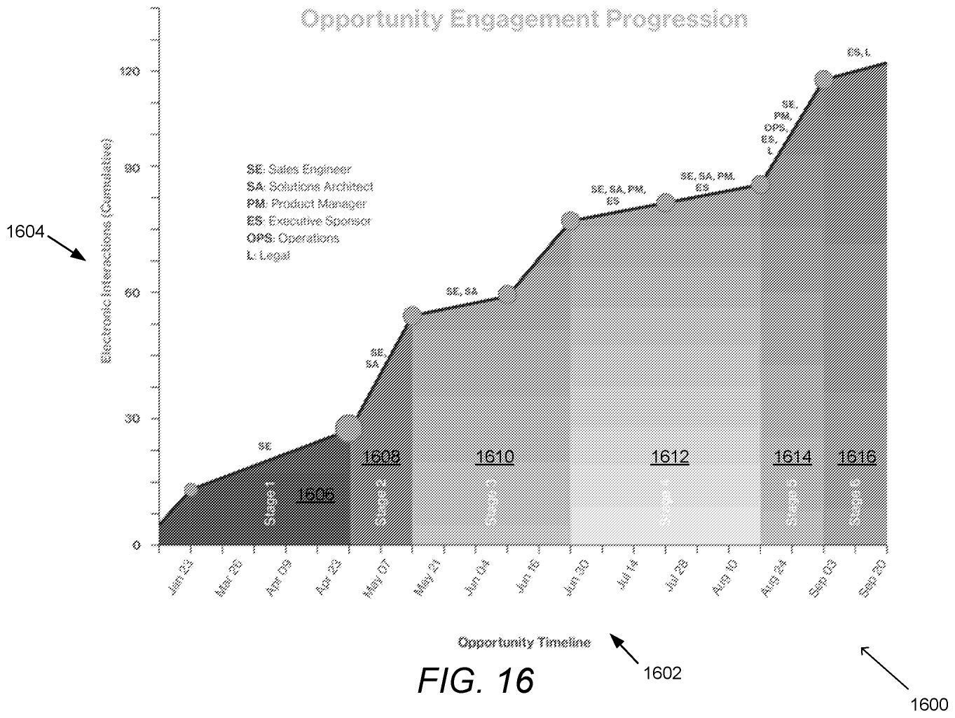

A diagram illustrating an opportunity engagement progression in accordance with an embodiment of the invention is shown in FIG. 16. The opportunity engagement progression 1600 may be illustrated as a graph having an x-axis 1602 representing time (may be referred to as an “opportunity timeline”) and a y-axis 1604 representing cumulative electronic interactions (e.g., EE actions, etc.). In some embodiments, the opportunity engagement progression 1600 may include various stages having electronic interactions with various groups such as, but not limited to sales engineer (SE), solutions architect (SA), product manager (PM), executive sponsor (ES), operations (OPS), and/or legal (L). For example, stage 1 1606 may include interactions with SE, and stage 2 1608 and stage 3 1610 may include interactions with SE and SA. Further, stage 4 1612 may include interactions with SE, SP, PM, ES. Moreover, stage 5 1614 may include interactions with SE, PM, OPS, ES, and L. In addition, stage 6 1616 may include interactions with ES and L.

Although specific sales performance considerations are discussed above with respect to FIGS. 14-16, any of a variety of sales performance considerations as appropriate to the requirements of a specific application may be utilized in accordance with embodiments of the invention. For example, in some embodiments, OERs may include various other metrics and definitions (e.g., win ratio for various players and/or groups). Further, SPA processes and/or reports may include any data described herein and the use of such data for sales performance considerations. Furthermore, opportunity engagement progression may be defined beyond just electron interactions and may utilize the various data described herein such as, but not limited to, EE action data. In addition, while processes are presented as in an order herein, alternative orders of operations may be utilized without departure from the spirit of the invention. While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. A non-transitory machine readable storage medium storing a program comprising instructions that, when executed by at least one processor of a server, cause the server to perform operations including:
receiving first employee action data associated with a first employee;
receiving second employee action data associated with a second employee; and
generating a plurality of groups, wherein the plurality of groups ranks employees based on the first employee action data and the second employee action data.

2. The non-transitory computer readable storage medium of claim 1, wherein the plurality of groups is generated using a machine learning engine.

3. The non-transitory computer readable storage medium of claim 2, wherein the machine learning engine is configured for a job function and the machine learning engine generates the plurality of groups based on the job function.

4. The non-transitory computer readable storage medium of claim 3, wherein the job function is revenue generated.

5. The non-transitory computer readable storage medium of claim 4, wherein the plurality of groups includes a Group A and a Group B, wherein the Group A includes employees that generated more revenue than employees in the Group B.

6. The non-transitory computer readable storage medium of claim 3, wherein the machine learning engine generates the plurality of groups based on recognizing phrases repeatedly used in the job function.

7. The non-transitory computer readable storage medium of claim 3, wherein the first employee action data and the second employee action data comprise email metadata.

8. The non-transitory computer readable storage medium of claim 3, wherein the first employee action data and the second employee action data comprise calendar metadata.

9. The non-transitory computer readable storage medium of claim 3, wherein the first employee action data and the second employee action data comprise meeting metadata.

10. The non-transitory computer readable storage medium of claim 3, wherein the first employee action data and the second employee action data comprise text metadata.

11. The non-transitory computer readable storage medium of claim 3, wherein the first employee action data and the second employee action data include chat metadata.

12. The non-transitory computer readable storage medium of claim 3 further comprising instructions that, when executed by the at least one processor, further cause the server to receive participant data and generate the plurality of groups based on the participant data.

13. The non-transitory computer readable storage medium of claim 12, wherein the participant data comprises participant's seniority level, participant's job junction, and participant company metadata.

14. The non-transitory computer readable storage medium of claim 3 further comprising instructions that, when executed by the at least one processor, further cause the server tor receive KPI metadata and generate the plurality of groups based on the KPI metadata.

15. The non-transitory computer readable storage medium of claim 14, wherein the KPI metadata comprises sales revenue.

16. The non-transitory computer readable storage medium of claim 1, wherein the first employee action data is received from a first employee device and the second employee action data is received from a second employee device.

17. The non-transitory computer readable storage medium of claim 1, wherein the first employee action data and the second employee action data are received from a 3^{rd} party service.

18. The non-transitory computer readable storage medium of claim 1 further comprising instructions that, when executed by the at least one processor, further cause the server to receive first user data and second user data and generate the plurality of groups based on the first user data and the second user data.

19. The non-transitory computer readable storage medium of claim 1 further comprising instructions that, when executed by the at least one processor, further cause the server to generate an impact score and generate the plurality of groups based on the impact score.

20. The non-transitory computer readable storage medium of claim 1 further comprising instructions that, when executed by the at least one processor, further cause the server to generate a Sales Performance Accelerator (SPA) report, wherein the SPA report provides differences in employee action data between the plurality of groups.
